(19) United States
(12) Patent Application Publication
(10) Pub. No.: US 2007/0021905 A1
(43) Pub. Date: Jan. 25, 2007

(54) Navigation system

(75) Inventors: Kenji Takashima, Obu-city (JP); Masanori Omi, Gifu-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/483,681

(22) Filed: Jul. 11, 2006

(30) Foreign Application Priority Data
Jul. 22, 2005 (JP) 2005-213271
Mar. 3, 2006 (JP) 2006-058288

(51) Int. Cl. G01C 21/00

(52) U.S. Cl. 701/201

(57) ABSTRACT

A navigation system for providing a navigation route of a travel between a start point and an end point based on a route search by using a predetermined condition includes a display unit for displaying the navigation route and/or a navigation route candidate with a condition name associated thereto. The predetermined condition with the condition name associated thereto yields a plurality of navigation route candidates as a result of the route search.

### CROSS REFERENCE TO RELATED APPLICATION

This application is based on and claims the benefit of priority of Japanese Patent Application No. 2005-213271 filed on Jul. 22, 2005, and Japanese Patent Application No. 2006-58288 file on Mar. 3, 2006, the disclosure of which are incorporated herein by reference.

### FIELD OF THE INVENTION

The present invention generally relates to a navigation system for a vehicle.

### BACKGROUND OF THE INVENTION

A conventional navigation system used in a vehicle typically determines a navigation route toward an inputted destination of a travel for navigating a user/driver in the vehicle. In addition, the conventional navigation system is capable of finding the navigation route that suits user's preference based on a predetermined set of preference conditions or the like. The route calculated by the navigation system is displayed or provided to the user/driver for navigation of the vehicle.

The navigation system having above-described navigation scheme typically calculates five or six route candidates, each of which respectively represents “Recommended route,” “Local road only,” “Highway (Toll road) included,” “Shortest distance,” “Alternative route” and the like. Those route candidates are mapped on a display of the navigation system by using respectively different colors with descriptive names mentioned above or the like.

The preference conditions used in the navigation system do not always find a route that best suits user's preference, because of their granularity, or a coarseness of condition settings. Therefore, use of the condition settings by combining a fixed condition and a user-specific condition is proposed, for example, in Japanese Patent Document JP-A-2004-125448. More practically, the navigation system disclosed in the above patent document uses five fixed conditions of “Recommended route,” “Local road only,” “Toll road included,” “Shortest distance,” and “Alternative route” in combination with user specific variables of time-consciousness (i.e., shorter travel time preferred/not preferred) and signal awareness (i.e., the number of traffic signals en route considered/not considered). That is, each of the five fixed conditions for route search is combined with one of four options for an improvement of specificity.

The navigation system in the above disclosure always displays five routes in spite of the improvement of specificity. That is, each of the searched routes always corresponds to one of the specific names mentioned above. In other words, each of the specifically named conditions have only one search result of navigation route in the search result for navigation.

However, the user/driver in the vehicle may determine the navigation route after comparison of plural route candidates actually mapped on the display of the navigation system. That is, for example, the route candidate of “Local road only” with signal awareness may look like more “attractive” or preferable than the route candidate without signal awareness that cannot be searched nor displayed on the map in the above described navigation system simultaneously with the signal awareness route. Further, a more preferred set of conditions for finding an optimum route may only be recognized after actually mapping and comparing the searched routes, thereby making the route search a repetitive process of condition setting trials and search result comparisons. Furthermore, the search condition may include a kind of specificity that has a must-inclusion portion of expressway or the like. This kind of specificity cannot be specified by using the condition settings in the above-described navigation system. Therefore, the user/driver of the navigation system may not be able to find a preferred navigation route by using the condition settings prepared by the navigation system.

### SUMMARY OF THE INVENTION

In view of the above-described and other problems, the present disclosure provides a navigation system that provides a navigation route having more specificity in terms of user preference of the navigation route.

The navigation system for providing a navigation route of a travel between a start point and an end point based on a route search by using a predetermined condition includes a display unit for displaying the navigation route and/or a navigation route candidate with a condition name associated thereto. The predetermined condition with the condition name associated thereto yields a plurality of navigation route candidates as a result of the route search. In this manner, the navigation system provides plural route candidates for a user of the navigation system based on the single predetermined condition specified by using the condition name.

In another aspect of the present disclosure, the navigation system includes a plural route search unit for searching for a plurality of navigation route candidates and a display unit for displaying a navigation route and/or the navigation route candidate for providing the navigation route/route candidate based on the route search by using a fixed search condition. In this manner, the navigation system provides the plural routes by using the single fixed condition of the route search.

In still yet another aspect of the present disclosure, the navigation system includes a storage unit for storing a plurality of the fixed search conditions, and the plural route search unit finds a plurality of navigation route candidates based on at least one of the fixed search conditions stored in the storage unit. In this manner, the navigation system can store increased number of fixed search conditions for finding a more preferred route in terms of user preference.

In still yet another aspect of the present disclosure, the navigation system provides the route search that allows the user for specifying divisional condition setting for the route search. That is, the navigation route candidates are searched for, for example, by employing two divisional search results respectively based on different conditions. In this manner, the navigation route may be made up from the at least two divisional search results for improved specificity and suitability to the user's preference.

In still yet another aspect of the present disclosure, the navigation system uses a weight coefficient for weighting a route attribute. In this manner, the navigation system finds plural route candidates by variably changing the weight coefficient for the route attribute. Further, the navigation route candidates are screened in terms of uniqueness before provision to the user. In this manner, duplicated display and/or provision of two identical route candidates is prevented.

In still yet another aspect of the present disclosure, the navigation system may provides entrance/exit selection of toll roads for the user. In this manner, the user estimates and/or calculates travel expense before the travel.

In still yet another aspect of the present disclosure, the navigation system uses route names, i.e., highway names, for providing more preferred navigation routes for the user. The route names or highway names are used to includes the route or the highway as at least a portion of the navigation route candidates in the route search. Further, selection range of the route or the highway can be specified by using a map on the display unit. In this manner, the highway or the specified route can be variably specified in terms of inclusion in the search condition of the navigation route candidates. Furthermore, distance of the travel may be considered in the route search. The distance of the travel may be used to limit a scope of the selection range of the route/highway, or may be used to sort the search result in an order of the travel distance or the like.

### BRIEF DESCRIPTION OF THE DRAWINGS

Other objects, features and advantages of the present invention will become more apparent from the following detailed description made with reference to the accompanying drawings, in which:

FIG. 1 shows a block diagram of a car navigation system in an embodiment of the present disclosure;

FIG. 2 shows a block diagram of functions in a control unit of the navigation system in FIG. 1;

FIG. 3 shows a flowchart of a process for route search based on a fixed condition of “Toll road”;

FIG. 4 shows an illustration of searched routes on a display unit of the navigation system;

FIG. 5 shows a modification for a flowchart of the process for route search shown in FIG. 3 in a second embodiment of the present disclosure;

FIG. 6 shows a modification for a flowchart of the process for route search shown in FIG. 5 in a third embodiment of the present disclosure;

FIG. 7 shows a flowchart of a process for a plural route search in a fourth embodiment of the present disclosure;

FIG. 8 shows a flowchart of a process for a preferred route determination in a fifth embodiment of the present disclosure;

FIG. 9 shows an illustration of highway name list screen on the display unit in the process in FIG. 8;

FIG. 10 shows an illustration of area selection map on a display unit in the process in FIG. 8; and

FIG. 11 shows a flowchart of a process for a route search after determining the preferred route.

### DETAILED DESCRIPTION OF THE PREFERRED EMBODIMENTS

Embodiments of the present disclosure are described with reference to the drawings. Like parts have like numbers in each of the embodiments.

(First Embodiment)

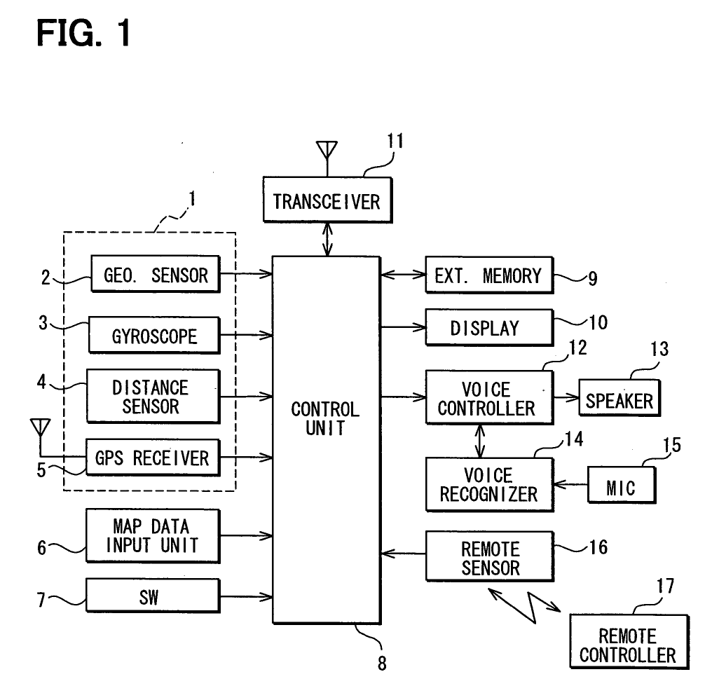

FIG. 1 shows a block diagram of a car navigation system in a first embodiment of the present disclosure. The navigation system includes a position detector 1, a map data input unit 6, operation switches 7, an external memory 9, a display 10, a transceiver 11, a voice controller 12, a speaker 13, a voice recognizer 14, a microphone 15, a remote controller sensor 16, a remote controller 17, a seat sensor 18 and a control unit 8. The control unit 8 controls the above-described devices connected thereto.

The control unit 8 is a well-known type computer that includes a CPU, a ROM, a RAM, an I/O and a bus line for connecting those components. The ROM stores a program that is executed by the control unit 8, and the CPU controlled by the stored program processes predetermined calculations and other procedures.

The position detector 1 includes a plurality of well-known type sensors such as a geomagnetism sensor 2, a gyroscope 3, a distance sensor 4, and a Global Positioning System (GPS) receiver 5. The geomagnetism sensor 2 is used to detect a magnetic direction of a vehicle, and the gyroscope 3 is used to detect a relative bearing of the vehicle. The distance sensor 4 is used to detect a travel distance of the vehicle, and the GPS receiver 5 receives a radio wave from a GPS satellite for detecting a position of the vehicle. These sensors and/or receivers can compensate respectively different characteristics of inherent errors by interacting complimentarily with each other. These sensors and/or receivers may selectively be used based on the accuracy of the output, and a steering rotation sensor, a speed sensor or the like (not shown in the figure) may additionally be utilized.

The map data input unit 6 is used to input digital map data such as road data, background drawing data, text data, facility data and the like. These data are provided by a memory medium such as a DVD-ROM, a CD-ROM. The map data input unit 6 retrieves these data from the DVD-ROM drive, the CD-ROM drive or the like (not shown in the figure) connected thereto, and input them to the control unit 8.

The map data in the memory medium includes links and nodes as road network data. The link and the node are respectively defined as a geometrical element (Link) with two points (Node) attached on both ends of the element. Therefore, the node generally corresponds to a crossing, a branch point or the like of a road, and the link generally corresponds to a segment of the road between two crossings or the like. In other words, roads in a real world are geometrically represented as a combination of the links and nodes. Link data of each road includes a link ID, a start node ID, an end node ID, a name attribute, a road number, plural road attributes respectively in association with cost and a road type (e.g., interstate, state road, local road, or the like). The road attributes includes a length of the road segment, a travel time of the road segment, a distinction of toll roads from free roads, easiness of travel, a road width and the like. Each of the road attributes has a cost, that is, a length cost, a travel time cost or the like. The road type is defined as one of an expressway (a free way or a highway), a toll road, a state road, a local road or the like. The road type may define plural classes in, for example, a highway. The definition of the highway may include a major highway, a normal highway and the like.

The operation switches 7 are disposed on, for example, the display 10 as touch switches, mechanical switches or the like, and are used for inputting various kinds of instructions for controlling road map on the display 10. That is, the road map control instructions include a map scale change instruction, a menu selection instruction, a destination setting instruction, a navigation start instruction, a current position correction instruction, a screen change instruction, a volume control instruction and the like.

The remote controller 17 has a plurality of switches (not shown in the figure) for inputting the same kind of instructions as the instructions from the operation switches 7. The remote controller 17 outputs control signals of instructions, and the control signals are provided for the control unit 8 through the remote controller sensor 16.

The external memory 9 is a memory medium, e.g., a memory card, a hard disk or the like, with read/write capability for storing data and/or information such as text data, image data, sound data as well as user information, e.g., a location of user's home and the like. The external memory 9 in the present disclosure stores five entries of fixed search conditions for use in the route search for a travel between a start point and a destination (an end point).

The fixed search condition is a set of plural weight coefficients for weighting the road attributes in the link data retrieved from the map data input unit 6. For example, the five road attributes of road length, travel time, toll/free distinction, easiness of travel and road width may be respectively weighted by weight coefficients of α1 (a length coefficient), α2 (a travel time coefficient), α3 (a toll/free coefficient), α4 (a travel easiness coefficient) and α5 (a road width coefficient). That is, the search condition is defined and fixed by using those five coefficients. The external memory 9 stores five kinds of fixed conditions, that is, five sets of fixed conditions respectively different to each other by having at least one respectively different coefficient. Each of the five fixed conditions bears a descriptive name of, for example, “Recommended route,” “Local road,” “Toll road,” “Shortest road,” and “Alternative route.” The five sets of fixed conditions may be stored in, for example, a ROM (not shown) or a non-volatile and non-erasable memory medium in the control unit 8 instead of the external memory 9. The number of fixed conditions may be different from five. That is, the number of fixed conditions may be one or other numbers different from five.

The display 10 is, for example, a liquid crystal display, an organic EL display or the like, and displays a position mark of the vehicle at a current position in a map display area of the display 10 on top of the road map generated by using the map data. The display 10 also displays other information such as a current time, traffic congestion information or the like in addition to the vehicle position and the road map.

The transceiver 11 is a communication device for providing communication with external information sources for the control unit 8. For example, traffic information, weather information, date information, facility information and advertisement information are received from external information resources by using the transceiver 11. The information may be outputted from the transceiver 11 after processing in the control unit 8.

The speaker 13 is used to output a predetermined sequence of sound such as navigation guidance voice, screen operation guidance voice, voice recognition result or the like based on a sound output signal from the voice controller 12.

The microphone 15 converts user's voice to an electric signal that is inputted to the voice recognizer 14. The voice recognizer 14 recognizes the inputted user's voice for pattern comparison with vocabulary data in an internal recognition dictionary (not shown in the figure), and outputs a recognition result to the voice controller 12 based on the resemblance of the user's voice to the stored vocabulary data.

The voice controller 12 controls the voice recognizer 14, and gives response to the user by talking back from the speaker 13. The voice controller 12 also controls the input of the recognition result of the voice recognizer 14 to the control unit 8.

The control unit 8 executes a predetermined process in response to the user's voice based on the recognition result of the voice recognizer 14, or in response to the user input from the operation switches 7 or from the remote controller 17. The predetermine process includes, for example, a map data storage process for storing the map data in the external memory 9, a map scale change process, a menu selection process, a destination setting process, a route search execution process, a route navigation start process, a current position correction process, a display screen change process, a volume control process and the like. Further, route navigation guidance information or the like processed in the control unit 8 is provided for the user from the speaker 13 in a suitable manner under control of the voice controller 12.

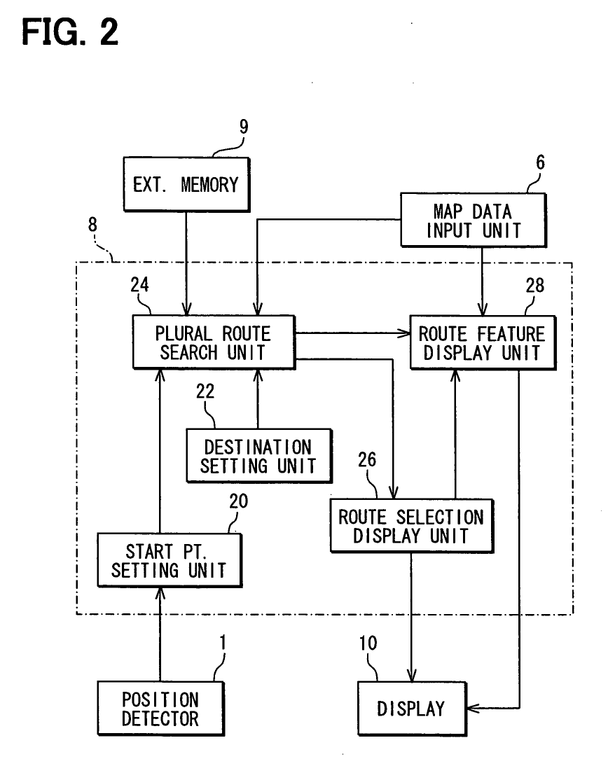

FIG. 2 shows a block diagram of functions in the control unit 8 of the navigation system in FIG. 1. The control unit 8 includes a start point setting unit 20, a destination setting unit 22, a plural route search unit 24, a route selection display unit 26 and a route feature display unit 28.

The start point setting unit 20 receives the user input of a location as the start point of the travel, or receives the current position of the vehicle detected by the position detector 1 as an input of the start point when the user does not input the start point.

The destination setting unit 22 displays a predetermined destination setting screen or outputs destination setting guidance voice from the speaker 13 for encouraging the user to input the destination of the travel. The user uses the operation switches 7 or the remote controller 17 for inputting a location of the destination by switch operation, or uses the microphone 15 for inputting the location of the destination by voice.

The plural route search unit 24 searches for a plurality of navigation routes between the start point and the destination determined by the start point/destination setting units 20, 22 based on the fixed conditions stored in the external memory 9.

The plural route search unit 24 in the present embodiment searches for plural routes for the fixed condition of “Toll road,” and searches for only one route for other four fixed conditions (“Recommended route,” “Local road,” “Shortest road,” and “Alternative route”).

The route search by using one of the four fixed conditions that yield only one route search result is described in the first place. The route search is conducted by using a labeling method such as Dijkstra method or the like based on a sum of road attribute costs in each link respectively weighted by the coefficient α.

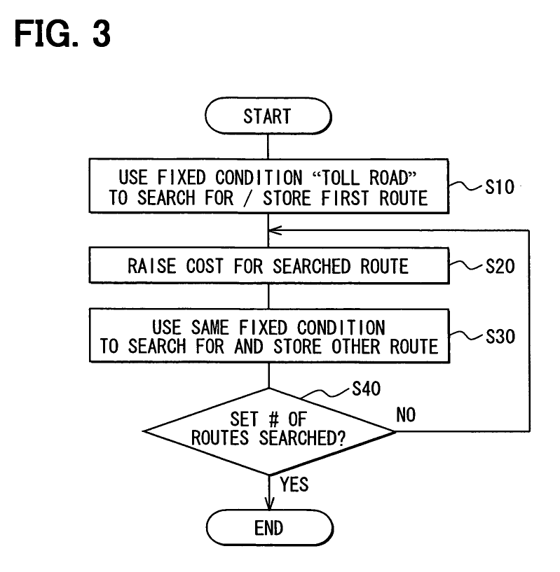

Then, the route search by using the fixed condition of “Toll road” is described with reference to a flowchart of the process in FIG. 3.

In step S10, the process uses the fixed condition of “Toll road” to search for and store a first navigation route in a RAM of the control unit 8 or the like. The process proceeds to step S20 after storing the searched navigation route.

In step S20, the process raises the cost of each link included in the first navigation route found in step S10 by a predetermined amount. When step S20 is executed after negation of the process in step S40, the process raises the cost of each link included in the navigation route found in an immediately preceding process. The process proceeds to step S30 after raising the cost. In addition, the plural costs in association with different road attributes may be uniformly raised, or may be raised separately. That is, for example, the road attributes having non-zero coefficients may only be raised. Further, the cost of the road attributes having relatively big impact on the total cost owing to the value of the coefficient may preferably be raised.

In step S30, the process used the fixed condition of “Toll road” in the same manner as in step S10 for the route search. In this case, as the first navigation route has an increased cost value, the same fixed condition yields a different navigation route from the route search in step S10. The process proceeds to step S40 after the route search.

In step S40, the process determines whether a predetermined number of the navigation routes are searched. The predetermined number of the routes may be fixed number, or may be variably changed by the user. The process returns to step S20 when the number of the searched routes is not equal to the predetermined value (step S40:NO). The process concludes itself when the number of the searched route has reached the predetermined number (step S20:YES).

The description with reference to FIG. 2 is resumed for the route selection display unit 26. The route selection display unit 26 determines whether two or more identical routes are included in the result of the route search conducted by the plural route search unit 24 based on comparison of the searched routes. The route selection display unit 26 displays on the display 10 only one of the two or more identical routes found by the plural route search unit 24. In other words, the route selection display unit 26 displays two or more identical routes only once. The route selection display unit 26 displays all of the respectively different navigation routes found by the plural route search unit 24. In this manner, efficiency of selecting the navigation route displayed on the display 10 is improved because the user can select one of the plural routes on the display 10 without having any concern that the selected route may be identical to one or more of the other routes.

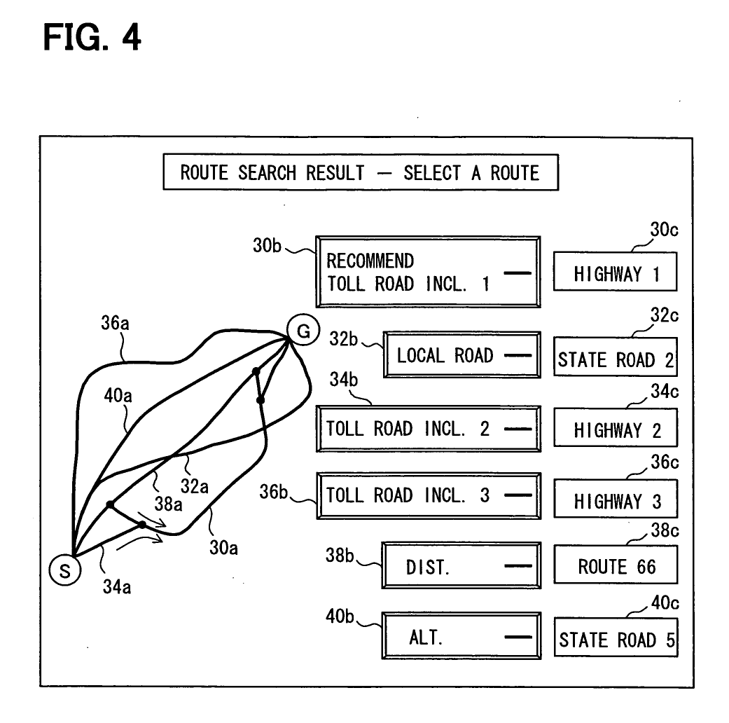

FIG. 4 shows an illustration of searched routes on a display 10 of the navigation system. In this case, the fixed condition of “Toll road” yielded three navigation routes, and one of the three routes is identical to the route searched by the fixed condition of “Recommended route.”

In FIG. 4, S represents the start point, G represents the destination, and six pieces of the navigation routes 30a, 32a, 34a, 36a, 38a, 40a are painted respectively in different colors in the screen. Each of the six routes 30a, 32a, 34a, 36a, 38a, 40a is also represented by a corresponding button having a descriptive label. The button for the six routes have numerals 30b, 32b, 34b, 36b, 38b, 40b. The user uses these buttons for selecting one of the six navigation routes. The six buttons are characterized by the same color as the navigation routes 30a, 32a, 34a, 36a, 38a, 40a and the name of the fixed conditions such as “Recommended route” or the like. In this manner, each of the six routes can be distinguished by the color of the route and by the fixed condition used to yield the respective search results. In addition, the button having two labels in one place indicates that the same navigation route 30a is yielded by the two different fixed conditions of “Recommended route” and “Toll road.”

The route feature display unit 28 in FIG. 2 determines the route feature of each of the plural navigation routes searched by the plural route search unit 24 based on the map data from the map data input unit 6, and the route feature of each of the plural navigation routes is displayed on the display 10.

In FIG. 4, representative road names 30c, 32c, 34c, 36c, 38c, 40c are displayed on the screen as the route features. The route feature display unit 28 retrieves the map data of each of the link in the searched navigation routes by the plural route search unit 24 from the map data input unit 6. As mentioned before, each of the link has the road name and the road number (road ID) associated thereto, thereby enabling the determination of road name and the road number for each link of the navigation routes. The representative road name of each navigation route is determined by selecting the road name that most frequently appeared in each navigation route based on the road name and road number data. Then, the representative road name for each navigation route is displayed on the display 10. In this manner, the user can recognize the road feature of each of the navigation routes more quickly and more easily compared to the simple graphical display of the navigation routes. That is, the user can efficiently select a preferred navigation route based on the representation on the screen.

As shown in FIG. 4, selection of the preferred navigation route is facilitated by the navigation routes 30a to 40a in association with the buttons 30b to 40b and the descriptive names 30c to 40c on the screen because of the ease of comparison between those items and the ease of reference of route features. The user can select and determine one of the navigation routes by selectively pressing one of the buttons 30b, 32b, 34b, 36b, 38b, 40b.

The navigation system in the present embodiment has five fixed conditions of “Recommended route,” “Local road,” “Toll road,” “Shortest road,” and “Alternative route” stored for use in the route search. The fixed condition of “Toll road” yields three navigation routes as the route search result. The search result having three routes is displayed on the display 10 with the descriptive labels of “Toll road.” In this manner, the number of searched routes exceeds the number of fixed conditions for the route search. Further, the one of the fixed conditions yields more than one navigation routes. Therefore, the user has the benefit of an increased number of navigation routes as the result of the route search. The increased number of the navigation route in the route search leads to an increased chance of finding a more preferable navigation route.

(Second Embodiment)

A second embodiment of the present disclosure is described in the following description. Again ,like parts have like numbers in the following embodiments.

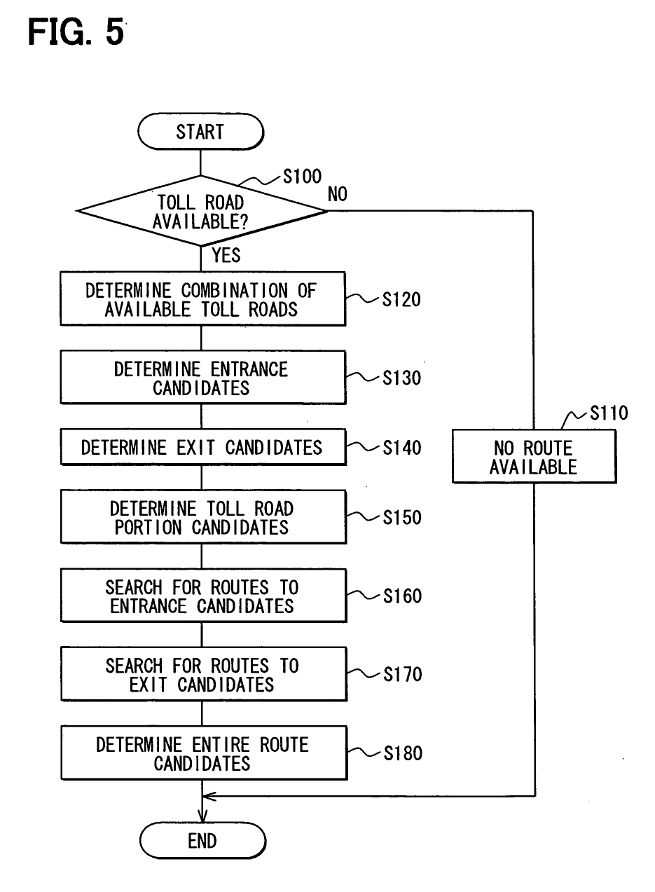

The navigation system in the second embodiment has the same set of components as the navigation system in the first embodiment. The control unit 8 of the navigation system has the same units 20, 22, 24, 26, 28 shown in FIG. 2. Difference of the second embodiment from the first one exists in a manner how the plural routes are searched based on the fixed condition of, for example, “Toll road.” That is, the navigation system executes the process shown in a flowchart in FIG. 5 instead of executing the process shown in FIG. 3.

FIG. 5 shows a modification for a flowchart of the process for the route search shown in the flowchart in FIG. 3.

In step S100, the process determines if any of the toll roads are available. That is, an area cropped from the map data based on the user input of the start point and the destination is examined for the determination that there is any toll road that is available for the current travel. The process proceeds to step S120 when a toll road available for the current travel is found in the area. The process proceeds to step S110 and determines that there is no toll road available for the current travel when no toll road is found is found in the area. The process concludes itself after step S110.

In step S120, the process determines a combination of available toll roads. The combination of the available toll roads can be described as a situation such as one of two toll roads between New York and New Jersey can selectively be combined with one of plural toll roads in suburban New Jersey. The process proceeds to step S130 after determining the combination.

In step S130, the process determines plural entrance candidates for the selected combination of toll roads. For example, entrance ramps to the inter-city toll road within a predetermined distance from the start point may be chosen as the entrance candidates. The entrance candidate may be the suburban toll road entrance if a suburban toll road is on the entrance side. The number of entrance candidates may be limited to be within a predetermined number for the ease of selection, or may not be limited for increased selection of entrance candidates provided for the user's disposal. The process proceeds to step S140 after determining the entrance candidates.

In step S140, the process determines exit candidates based on the combination of the toll road determined in step S120. For example, exit ramps from the suburban toll road within a predetermined distance from the destination may be chosen as the exit candidates. The exit candidate may be the inter-city toll road exit if an inter-city toll road is on the exit side. The number of exit candidates may be limited to be within a predetermined number for the ease of selection, or may not be limited for increased selection of exit candidates provided for the user's disposal. The process proceeds to step S140 after determining the exit. The process proceeds to step S150 after determining the exit candidates.

In step S150, the process determines plural candidates of the navigation route for toll road portion based on the combination of the entrance candidates and the exit candidates determined in steps S130 and S140. When the number of candidates exceeds a predetermine limit number, the navigation route candidates may be selectively decreased within the limit based on an order of, for example, the total amount of toll for the toll road portion of the navigation route candidates. The entrance candidates, exit candidates and the navigation route candidates for the toll road portion may be determined based on a prepared set of association determiners stored in the external memory 9 or the like. The process proceeds to step S160 after determination of the toll road portion candidates.

In step S160, the process searches for routes from the start point to the plural entrance candidates. The route search is conducted by using a well-known method such as Dijkstra method or the like, and the entrance candidates are set as the destination with the fixed route search condition of “Recommended route” or “Shortest distance.” The process proceeds to step S170 after the route search for the portion between the start point and the entrance candidates.

In step S170, the process searches for the routes from the exit candidates to the destination in the same manner as described in step S160. The process proceeds to step S180 after the route search for the portion between the exit candidates and the destination.

In step S180, the process determines entire navigation route candidates by combining the three parts of the route candidates, that is, the toll road portion, the start point to entrance portion and the exit to destination portion. In this manner, plural sets of the entire navigation route candidates are prepared. After uniqueness of the route candidates is cross-checked with the route candidates based on other fixed conditions and redundant candidates are eliminated as in the first embodiment, the navigation route candidates are displayed on the display 10. The process concludes itself after step S180.

The process of the route search in the second embodiment determines plural navigation route candidates having respectively different entrance/exit to the toll road portion of the navigation route, thereby increasing the number of options of navigation route selection for preferably serving the user.

(Third Embodiment)

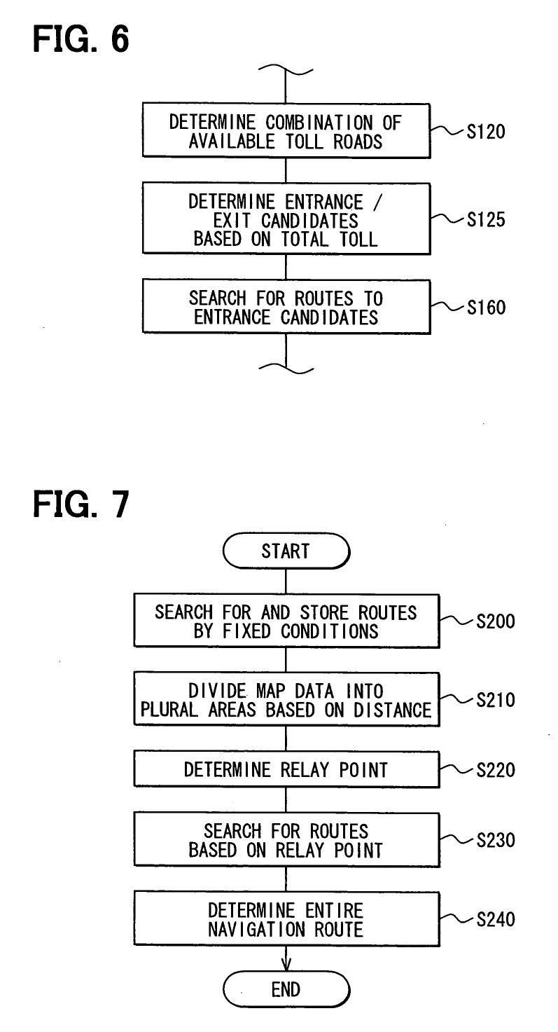

A third embodiment of the present disclosure is described with reference to the drawings. In the third embodiment, a portion of the process in the flowchart in FIG. 6 is alternatively used for the portion of the process shown in FIG. 5. That is, steps S130 to S150 in FIG. 5 is replaced with step S125 in FIG. 6. The rest of the process in steps S100 to S120 and steps S160 to S180 are same as FIG. 5.

In step S125, the process determines total amount of toll for each of the combinations of the toll roads determined in step S120 based on a predetermined toll table. That is, the total amount of toll for each of the combinations of the toll roads is calculated, and sorted in, for example, an ascending order for categorizing. Categorizing, in this case, means that the toll amount is divided into plural slot for the calculation of the user's budget. More practically, the category 1 may be between $10 to 20, category 2 between $20 to 30 and category 3 between $30 to 40 or the like. The range of each category may be determined as constant or may be variably determined.

After categorizing the total amounts of toll, combinations of the toll roads from each category are chosen for determination of entrance/exit candidates. In this case, an entrance and an exit are determined as a pair because of the categorization of the total toll, and plural combinations of the toll roads may be chosen from each category. The pair of the entrance/exit may be made within a predetermined number in each category for broader selection, in an ascending/descending order of the total amount of toll. The total amount of toll may be associated with the distance from the start point or destination for further categorization.

The entire navigation route is searched for after determining the entrance and exit candidates as plural sets of toll road combinations. That is, the start point to entrance portion and the exit to destination portion are searched for in order to be combined with the toll road portion as in the second embodiment.

Then, the navigation route candidates are displayed with the total amount of toll on the display 10 after the redundancy check. In this manner, the user can plan and determine the navigation route of the travel in terms of affordable toll amount for the travel.

(Fourth Embodiment)

A fourth embodiment is described with reference to the drawings. The navigation system in the fourth embodiment, same as in the third embodiment, includes the components in FIG. 1, and the control unit 8 of the navigation system has the same units 20, 22, 24, 26, 28 shown in FIG. 2. Difference of the fourth embodiment from the first one exists in the process executed by the plural route search unit 24.

FIG. 7 shows a flowchart of a process for the route search in the fourth embodiment of the present disclosure.

In step S200, the process searches for the plural navigation routes by using the fixed condition of five types in the external memory 9, that is, conditions of “Recommended route,” “Local road,” “Toll road,” “Shortest road” and “Alternative route” for finding one navigation route for each condition. The searched routes are stored, for example, in the memory 9. The process proceeds to step S210 after the route search.

In step S210, the process divides the map data including the start point and the destination into plural areas based on the distance between the start point and the destination. The number of areas of division may be a predetermined number or may be arbitrarily determined. The number may be greater than the number of fixed conditions (i.e., five conditions in this case). The process proceeds to step S220 after the determining the area division.

In step S220, the process determines relay points. The relay point is defined as a crossing point of a boundary of the areas determined in step S210 and the navigation route between the start point and the destination. The relay point is determined by using one predetermined choice from the navigation routes searched for in step S200. The process proceeds to step S230 after determining the relay points.

In step S230, the process searches for the navigation route in each of the areas determined in step S210 by using the fixed conditions. The process uses the relay point either as a route start point or a route destination in the area. The route search in some areas uses the fixed condition for finding the plural navigation routes, and the route search in other areas uses other fixed condition for yielding a single navigation route. The process proceeds to step S240 after the route search in each area.

In step S240, the process combines the searched routes found in each area for determining the entire navigation route. The process concludes itself after step S240.

The process in steps S210 to S240 is more practically explained based on a simple example. That is, the map data is divided into two areas in step S210 based on the distance between the start point and the destination, and the relay point is determined as a crossing point of the navigation route searched by using the “Local road” condition in step S200 and the area boundary. Then, the process searches for the navigation route from the relay point to the destination by using the fixed condition of “Shortest distance” in step S230. The process combines the searched route between the start point and the relay point by using the fixed condition of “Local road” with the route found in step S230 to determine the entire navigation route in step S240.

The navigation system in the fourth embodiment divides the map data into plural areas for applying different fixed condition to the route search in each of the divided areas. In this manner, the number of outputs of the navigation route from the route search by the navigation system in the fourth embodiment exceeds the number of the fixed conditions used in the route search.

(Fifth Embodiment)

A fifth embodiment is described with reference to the drawings. The fifth embodiment of the navigation system uses the same components as the first embodiment, but is differently controlled from the other embodiments described above.

In the fifth embodiment, the process determines the entire navigation route based on an user input of an available highway or a major road between the start point and the destination of the travel (route search based on a preferred road).

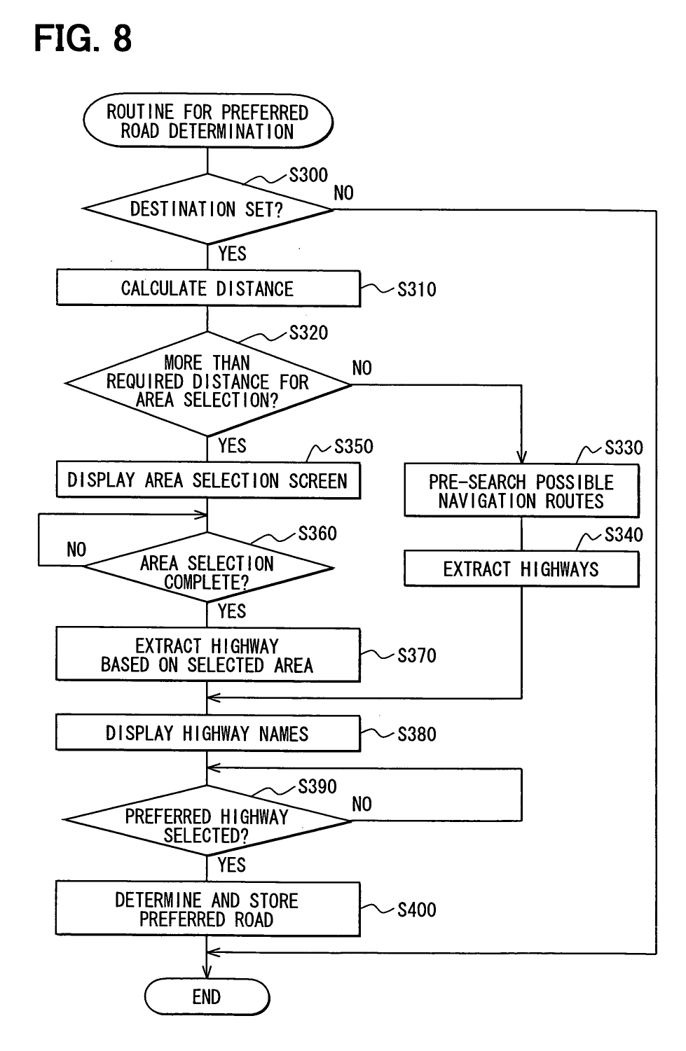

The determination of the preferred road is conducted by executing the process shown in the flowchart in FIG. 8. The process in FIG. 8 repeats itself at a predetermined interval.

In step S300, the process determines whether the destination of the travel is set. The destination itself is set by executing the destination setting unit 22, and the setting result is examined in step S300. The process proceeds to step S310 when the destination is determined to be set (step S300:YES). The process concludes itself when the destination is not set (step S300:NO).

In step S310, the process calculates a linear distance between the start point and the destination of the travel based on the map data inputted by the map data input unit 6. The start point of the travel may be the current position of the vehicle, or may be an already inputted start point. The process proceeds to step S320 after distance calculation.

In step S320, the process determines whether the linear distance is equal to or greater than a required distance for area selection. The required distance is, for example, a length of several hundred kilometer or the like. The required distance is used to set a standard of a long distance drive. The value of the required distance may be changed by the user. The process proceeds to step S330 when the linear distance between the start point and the destination is equal to or greater than the required distance (step S320:NO). The process proceeds to step S350 when the linear distance is less than the required distance (step S320:YES).

In step S330, the process executes pre-search for finding all possible and/or available navigation routes between the start point and the destination. The possible navigation routes can be searched for within a plausible amount of time because of the filtering by the required distance in step S320. The process proceeds to step S340 after the route search.

In step S340, the process extracts highways from the all possible routes searched for in step S330 based on the road attribute in the map data. The categorization of the highway or the major road may be determined in advance. For example, the highway includes an expressway, a toll road, a state road and the like. The process proceeds to step S380 after extracting highways.

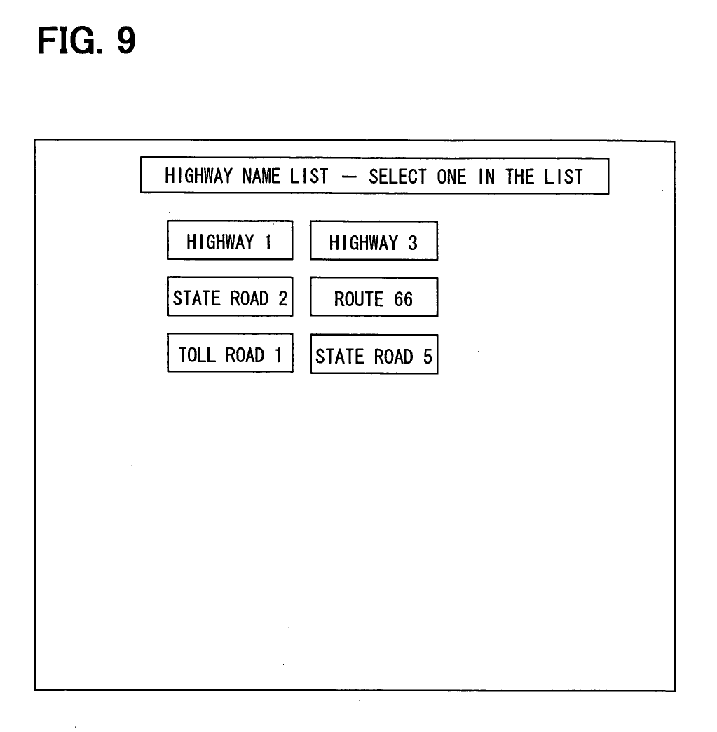

In step S380, the process displays on the display 10 highway names extracted in step S340. FIG. 9 shows an illustrative example of highway names listed on the display 10. The message on the display 10 reads, for example, “Please select a preferred road in the list.” or the like with six options for highway selection. The process proceeds to step S390 after listing the highway names.

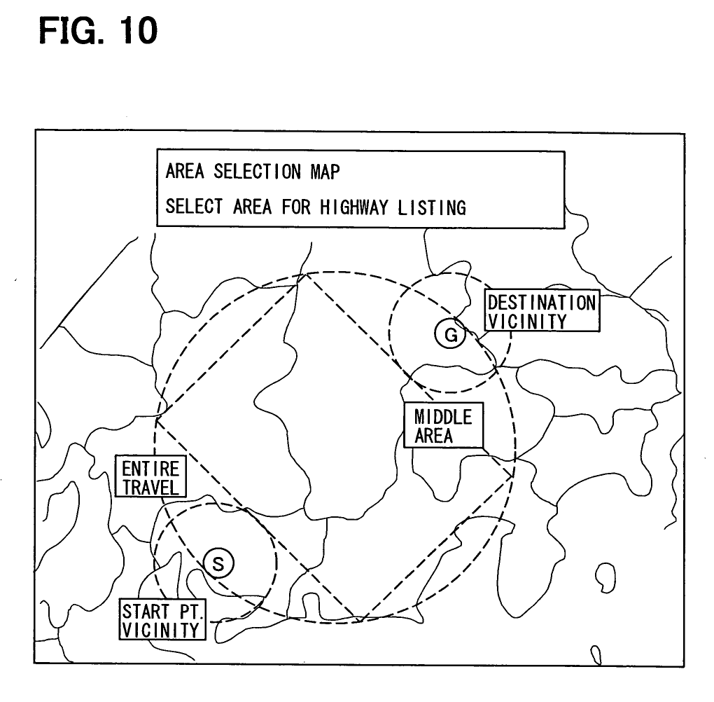

After an affirmative determination of step S320 to be succeeded by step S350, the process displays area selection screen on the display 10. That is, when the linear distance between the start point and the destination is equal to or greater than the required distance, the user can select an area in the map data for specifying the highway to be included in the navigation route. FIG. 10 shows an illustrative example of the area selection screen on the display 10. The message on the display 10 reads, for example, “Please select an area for highway listing.” or the like. In the illustrative example, area selection options of “Start Point Vicinity,” “Destination Vicinity,” “Entire Travel” and “Middle Area” are shown. The “Start Point Vicinity” and the “Destination Vicinity” are defined a circle centered on a point S/G having a radius of 20 kilometer or the like. The radius of the circle is determined as a relatively small area relative to the distance of the travel for plausibility of route calculation. The “Entire Travel” is defined as a circular area that includes both of the start point S and the destination G of the travel in this example. The “Middle Area” is defined as a rectangle that is circumscribed by the circles of the “Start Point Vicinity” and the “Destination Vicinity” within the circle of the “Entire Travel” besides excluding the start point/destination points S/G. The process proceeds to step S360 after displaying the area selection screen.

In step S360, the process determines whether one of the area selection options is selected by the user. The process repeats step S360 when the area selection is not complete (step S360:NO). The process proceeds to step S370 when the area selection is complete (step S360:YES).

In step S370, the process extracts all highways in the selected area from the map data. The process proceeds to step S380 when the selected area is either of the vicinity type area. The selected area of the “Entire Travel” or “Middle Area” may extract a excessive number of highways for the listing. In that case, the number of extraction may be suppressed to a predetermined number after sorting the original extraction by the distance or the like. Step S380 comes after the extraction in step S370 for displaying the highway names on the display 10.

In step S390, the process determines whether the user has selected a preferred road from the highway names listed on the display 10. The process repeats step S390 when the user selection of the preferred road is negated (step S390:NO). The process proceeds to step S400 when the preferred road selection by the user is complete (step S400:YES).

In step S400, the process determines and stores the preferred road selected in step S390. The process concludes itself after storing the preferred road.

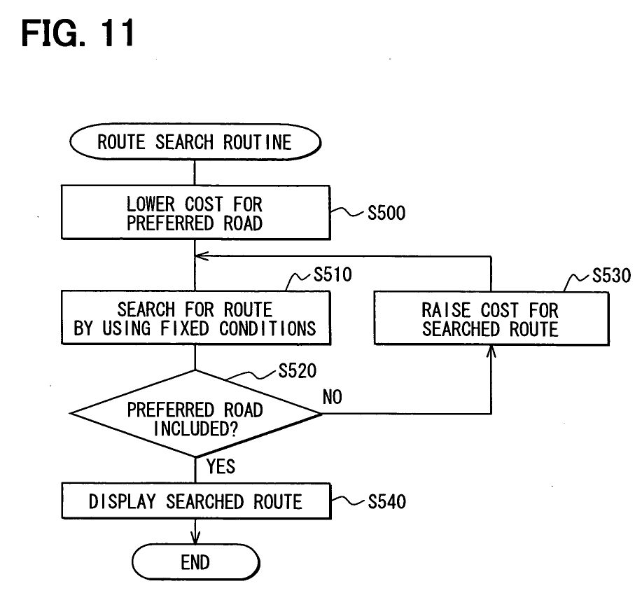

FIG. 11 shows a flowchart of a process for a route search after determining the preferred road.

In step S500, the process lowers the cost of road attribute for the preferred road determined in step S400 relative to other roads. In other words, the cost of the other roads may be raised relative to the preferred road. The process executes cost adjustment in a predetermined method. The process proceeds to step S510 after the cost adjustment.

In step S510, the process searches for and finds one navigation route for each of the five fixed conditions mentioned in the first embodiment. The process proceeds to step S520 after the route search for the five fixed conditions.

In step S520, the process determines whether each of the five searched routes includes the preferred road. The process returns step S510 after raising the road attribute cost of the searched routes (i.e., the routes that do not include the preferred road) by a predetermined amount in step S530 when preferred road inclusion in the searched route is negated (step S520:NO). After a second iteration of step S510, the route search conducted by the process is limited to the fixed condition(s) that did not yield the navigation route with the preferred road included therein. In other words, step S520 is affirmatively passed after each of the five fixed conditions respectively finds one navigation route in the iteration of steps S51 0 to S530. The process proceeds to step S540 when the process affirms step S520 (step S520:YES).

In step S540, the process displays the five navigation routes that respectively include the preferred road on the display 10 based on the five fixed conditions. The process concludes itself after displaying the navigation routes on the display.

The navigation system in the present embodiment allows the user to select a highway to be included in the navigation route before conducting the route search. Further, the navigation system provides the user a plurality of searched navigation routes that respectively include the preferred road. In this manner, the navigation system serves the user in a more preferable manner in terms of inclusion of the preferred road.

In addition, the navigation system securely extracts all available highways between the start point and the destination (step S340) by taking all possible navigation routes into consideration (step S330) for the benefit of the user when the travel is within a predetermined distance.

Furthermore, the navigation system excludes unwanted highways to be included in the navigation route by providing the options of area selection for the user (area selection screen in step S350). The provision of the area selection options serves as another benefit of the user in terms of the ease of selection of the preferred road.

Although the present disclosure has been fully described in connection with the preferred embodiment thereof with reference to the accompanying drawings, it is to be noted that various changes and modifications will become apparent to those skilled in the art.

For example, the display of the searched routes on the display unit may be alternatively switched by the user's operation instead of displaying all routes at the same time.

Further, the route search may be based on a user determined condition instead of the fixed condition for finding the plural navigation routes.

Furthermore, the route search may be represented on the display unit by using the combination of a base condition and an additional condition. For example, the two navigation routes found on the “Toll road” condition with and without the option of the shorter travel time preference may be distinctively represented as the combination of two conditions on the display unit.

Furthermore, the route search may be represented only by the base condition of the search. That is, the two different routes found by the above combination of the base condition and the additional condition may simply be associated to and represented by the base condition.

Furthermore, the fixed condition for yielding the plural routes may be different from the “Toll road” condition as described in the first and fourth embodiments.

Furthermore, the extraction of the highways may not be limited to a predetermined number even when the travel distance is greater than the required distance for the area selection. That is, the greater number of highways may be extracted from the map data for the broader and more detailed route search for the benefit of the user.

Furthermore, limitation of the number of the extracted highways may be imposed on the highway selection based on the area of the vicinity types, or may not be imposed on the highway selection based on the area selection of the “Entire travel” or the “Middle Area” type

Furthermore, the highway name list may be accompanied by the map for displaying the navigation route represented therein.

Furthermore, plural highways may be selected from the highway name list instead of a single highway name in the highway name list.

Such changes and modifications are to be understood as being within the scope of the present disclosure as defined by the appended claims.

What is claimed is:

1. A navigation system for providing a navigation route of a travel between a start point and an end point based on a route search by using a predetermined condition, the navigation system comprising:
a display unit for displaying the navigation route and/or a navigation route candidate with a condition name associated thereto,
wherein the predetermined condition with the condition name associated thereto yields a plurality of navigation route candidates as a result of the route search.

2. A navigation system for providing a navigation route of a travel between a start point and an end point based on a route search by using a fixed search condition, the navigation system comprising:
a plural route search unit for searching for a plurality of navigation route candidates; and
a display unit for displaying a navigation route and/or the navigation route candidate.

3. The navigation system as in claim 2 further comprising:
a storage unit for storing a plurality of the fixed search conditions,
wherein the plural route search unit finds a plurality of navigation route candidates based on at least one of the fixed search conditions stored in the storage unit.

4. The navigation system as in claim 3,
wherein the fixed search conditions include the fixed search condition of toll road preference for use in the route search that assigns higher priority for the navigation route candidate at least partially including a toll road.

5. The navigation system as in claim 4,
wherein the plural route search unit uses each of the plurality of the fixed route search conditions for the route search,
the plural route search unit provides a same number of navigation route candidates as the number of the fixed route search conditions based on the route search of an entire travel between the start point and the end point,
the plural route search unit uses a plurality of search blocks in the route search for finding the navigation route candidate,
the plural route search unit applies the fixed search condition to at least one of the search blocks in the route search and applies other fixed search condition to a rest of the search blocks for finding an additional navigation route candidate.

6. The navigation system as in claim 2 further comprising:
a first route search unit in the plural route search unit for finding a first navigation route candidate based on a total route cost derived by summing a route attribute cost of each link multiplied by a weight coefficient, wherein a plurality of the links represents a route in map data; and
a second route search unit in the plural route search unit for finding a second navigation route candidate based on the total route cost derived by summing the route attribute cost of each link multiplied by the weight coefficient, wherein the route attribute cost of each link that represents the first navigation route candidate except for at least a portion of the first navigation route candidate is raised relative to the route attribute cost at a time of finding the first navigation route candidate,
wherein the fixed route search condition defines a set of plural weight coefficients for each of the plural route attributes.

7. The navigation system as in claim 2 further comprising:
a route selection display unit for displaying on the display unit a plurality of respectively different navigation route candidates on the display unit based on the route search by the plural route search unit after representing identical navigation route candidates in the plurality of the navigation route candidates as a single route candidate.

8. A vehicular navigation system for finding and providing a navigation route between a start point to an end point, the vehicular navigation system comprising:
a display unit for displaying the navigation route,
wherein the navigation route includes a plurality of respectively different navigation routes calculated between a same start point and a same end point, and
each of the respectively different navigation routes at least partially includes a toll road with one of respectively different entrance into and exit from the toll road.

9. The vehicular navigation system as in claim 8,
wherein the plurality of the calculated navigation routes belong to at least two different toll blocks in terms of total amount of toll when the toll road is incrementally priced.

10. The vehicular navigation system as in claim 2 further comprising:
a route feature display unit for displaying a representation of distinction of the navigation route.

11. The vehicular navigation system as in claim 10,
wherein the representation of distinction of the navigation route is a name of a highway included in the navigation route.

12. A navigation system for providing a navigation route of a travel between a start point and an end point based on a route search, the navigation system comprising:
a display unit for displaying the navigation route and/or a navigation route candidate,
wherein selection of route names is displayed on the display unit for accepting an user input regarding inclusion of a specific route in the navigation route, and
the route search of the navigation route is conducted based on the user input of at least one of the route names for inclusion of the route specified by the at least one of the route names as at least a portion of the navigation route candidate.

13. The navigation system having map data with specificity of highway attribute assigned thereto for representing a highway with reference to a highway name, the navigation system as in claim 12 further comprising:
a highway selection unit for selecting at least one highway from the map data in a scope that includes the start point and the end point of the travel;
a highway name display unit for displaying the highway name included in the navigation route candidates selected in the highway selection unit; and
a navigation route display unit for displaying at least one of the navigation route selected from the navigation route candidates based on the user input.

14. The navigation system as in claim 13 further comprising:
a pre-selection unit for selecting a plurality of navigation route candidates specified at least partially based on a predetermined condition designed for highway determination,
wherein the highway selection unit selects the highway from the plurality of the navigation route candidates based on the map data with specificity of the highway attribute.

15. The navigation system as in claim 14,
wherein the predetermined condition designed for highway determination is used for the route search that yields the navigation route of the travel between the start point and the end point.

16. The navigation system as in claim 13 further comprising:
a distance calculator for calculating a travel distance between the start point and the end point of the travel; and
a selection range display unit for displaying on the display unit a plurality of respectively different selection ranges that at least include one of the start point and the end point of the travel when the travel distance calculated by the distance calculator is equal to or greater than a predetermined distance required for range selection,
wherein the highway selection unit selects the plurality of the highways from roads in the selection ranges based on the map data with the specificity of the highway attribute.

17. The navigation system as in claim 16,
wherein the selection range display unit displays at least one selection range that extends within a predetermined distance from the start point of the travel, and
the predetermined distance is characterized as a short distance relative to a total distance between the start point and the end point of the travel.

18. The navigation system as in claim 16,
wherein the selection range display unit displays at least one selection range that extends within a predetermined distance from the end point of the travel, and
the predetermined distance is characterized as a short distance relative to a total distance between the start point and the end point of the travel.

19. The navigation system as in claim 16,
wherein the selection range display unit displays at least one intermediate selection range that excludes both of the start point and the end point of the travel.

20. The navigation system as in claim 16,
wherein the selection range display unit displays at least one selection range that includes both of the start point and the end point of the travel.

21. The navigation system as in claim 19,
wherein the highway selection unit selects the plurality of the highways in an order of length included in the intermediate selection range when the intermediate.
